(19) United States
(12) Patent Application Publication
(10) Pub. No.: US 2006/0132942 A1
(43) Pub. Date: Jun. 22, 2006

(54) Motor vehicle rear view safety mirror

(76) Inventors: Richard A. Matney, Boca Raton, FL (US); Alisa J. Matney, Boca Raton, FL (US)

Correspondence Address: ALVIN S. BLUM, 2350 DELMAR PLACE, FORT LAUDERDALE, FL, 33301, US

(21) Appl. No.: 11/015,846

(22) Filed: Dec. 17, 2004

(51) Int. Cl. G02B 5/08

(52) U.S. Cl. 359/864; 359/866

(57) ABSTRACT

A rear view safety mirror (100) provides a full view of the rear area or a rear interior portion of a motor vehicle. The rear view safety mirror (100) includes a frame (106) that is adjustably attachable to a front portion of the motor vehicle. At least one mirror is adjustably attached to the frame and adjustably positionable relative to the front portion of the motor vehicle. The frame (106) can include a first and second frame sections (103 and 105). First and second mirrors (102 and 104) are respectfully positioned within the first and second frame sections (103 and 105). The first and second mirrors (102 and 104) are independently and contemporaneously adjustable, allowing for independent viewing of the rear area or rear interior portion of the motor vehicle by a person located at the front portion of the motor vehicle.

### FIELD OF THE INVENTION

The present invention generally relates to a safety mirror, and more particularly relates to a rear view safety mirror for a motor vehicle.

### BACKGROUND OF THE INVENTION

Motor vehicles are designed with rear view mirrors for allowing a driver to view what is behind the motor vehicle. The rear view mirrors are typically mounted to the front windshield and positioned to allow the driver to view through the rear windshield. As a result of the position and configuration of the rear view mirror a number of blind spots, where the driver cannot see, are present. The most notable blind spot is the rear seating area or rear interior portion of the motor vehicle. Additionally, the standard rear view mirror does not allow for a person seated in the front passenger seat to view the rear seating area or rear interior portion of the motor vehicle.

When transporting a child in a motor vehicle, it is important for the driver and front passenger to see the child in the rear seat. The standard factory installed rear view mirrors do not allow for this in-vehicle rear viewing. A number of devices have been developed to provide rear viewing from a vehicle. U.S. Pat. No. 5,949,595 (“Kissinger”) discloses a rear view mirror with left and right side mirrors for viewing blind spots outside the vehicle. U.S. Pat. No. 5,557,467 (“McColgan et al.”) discloses a rear view mirror having a first planar reflective surface and a second longitudinally convex reflective surface providing a wider field of rearward vision. While each of these mirrors provides an increased field of rearward vision, they both require the removal and replacement of the factory installed rear view mirror.

U.S. Pat. No. 5,106,177 (“Dolasia”) discloses a removable and storable surveillance driving mirror which can be attached to any suitable point in the vehicle, for example to the existing rear view mirror. The Dolasia is a single mirror that provides a limited viewing area. Additionally, the mirror is intended for use by the driver.

Therefore a need exists to overcome the problems with the prior art as discussed above.

### SUMMARY OF THE INVENTION

The present invention, according to an exemplary embodiment, provides a rear view safety mirror that allows a full view of the rear area or rear interior portion of a motor vehicle. A rear view safety mirror, according to an embodiment of the present invention, includes a frame for supporting at least one mirror that is adjustable for viewing of the rear area or rear interior portion of the motor vehicle. In an alternative embodiment, the rear view safety mirror includes a frame having first and second frame sections. First and second mirrors are respectively positioned within the first and second frame sections. The first and second mirrors are independently adjustable, allowing for independent and contemporaneous viewing of the rear area or rear interior portion of the motor vehicle. The first and second mirror are adjustably positionable relative to the front portion of the motor vehicle by a plurality of position adjustment points such that a person in the front portion of the motor vehicle viewing through any one of the first and second mirrors has facilitated rear viewing of a rear area in the motor vehicle.

The rear view safety mirror can be positioned proximal to the factory installed rear view mirror, such as in a location that is above, below, to the left of, and/or to the right of, the factory installed rear view mirror. The rear view safety mirror can be attached to the front windshield with a suction cup attachment member. The attachment member includes an adjustment member, which when used independently or in combination with the mirror adjustment member allows for full viewing of the rear area or rear interior portion of the motor vehicle. The viewing of the rear area or rear interior portion of the motor vehicle through the rear view safety mirror of the present invention can be done by a person located at the driver seat, or a person located at a front passenger seat, or it can be contemporaneously done by two persons located at both the driver and passenger seats, respectively.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 depicts the rear view safety mirror of the present invention;

FIG. 2 is a front planar view of the rear view safety mirror of FIG. 1;

FIG. 3 is a side cut-away view of the rear view safety mirror of FIG. 1, including frame and mirror adjustment members;

FIG. 4 is a side cut-away view of an alternative embodiment of the rear view safety mirror of FIG. 1, including an alternative frame attachment member;

FIG. 5 is a side cut-away view of the rear view safety mirror of FIG. 1, including an alternative frame adjustment member;

FIG. 6 is a side cut-away view of an alternative embodiment of the rear view safety mirror of FIG. 1, including an alternative mirror adjustment member;

FIG. 7 is a side view of an alternative embodiment of a rear view safety mirror of the present invention, including an attachment member and a mirror adjustment member;

FIG. 8 is a side view of the rear view safety mirror of FIG. 7, including an alternative mirror adjustment member;

FIG. 9 is a sectional view of the rear view safety mirror of FIG. 8, including an alternative mirror adjustment member;

FIG. 10 is a sectional view of the attachment member of the rear view safety mirror of FIG. 8;

FIG. 11 is a side view of the rear view safety mirror of FIG. 7, including an alternative attachment member;

FIG. 12 is a sectional view of the rear view safety mirror of FIG. 7, including an alternative attachment member;

FIG. 13 is a schematic representation of the rear viewing area from the driver's seat through the rear view safety mirror of the present invention; and

FIG. 14 is a schematic representation of the rear viewing area from the front passenger seat through the rear view safety mirror of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

The present invention, according to an embodiment, overcomes problems with the prior art by providing a full view of the rear seating area or rear interior portion of the motor vehicle, with an easily installed and usable device.

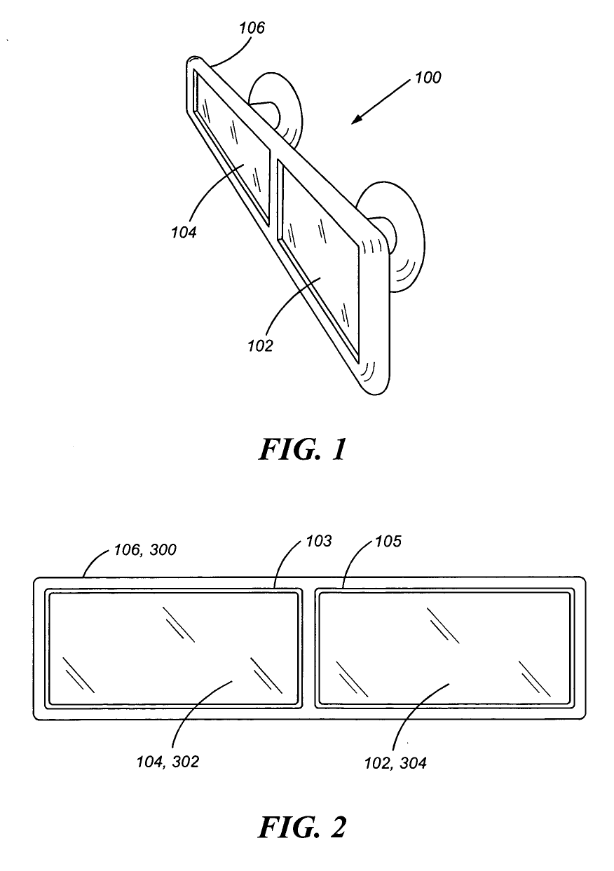

According to an embodiment of the present invention, as shown in FIGS. 1 and 2, a rear view safety mirror 100 of the present invention includes first and second mirrors 102 and 104. The first and second mirrors 102, 104, are independently positioned in first and second sections 103 and 105 of frame member 106. The independent positioning of the first and second mirrors 102 and 104 allows the first and second mirrors 102 and 104 to be independently adjusted within the frame 106. Note in this example, as illustrated in FIG. 1, that the frame member 106 includes a first side and at least a second side, where the first side provides the first frame section and the second frame section for positioning therein the first and second mirrors, respectively. The at least a second side includes all other sides of the frame member 106. As shown in FIG. 1, first and second support structures, each including a suction cup, attach the frame 106 to a surface such as the inside of the front windshield of a motor vehicle. While the first and second support structures are shown as being mechanically coupled to the back side of the frame member 106, it should be understood that each of the first and second support structures can be mechanically coupled to a different side of the frame member 106 and attaching it to the front windshield of the motor vehicle.

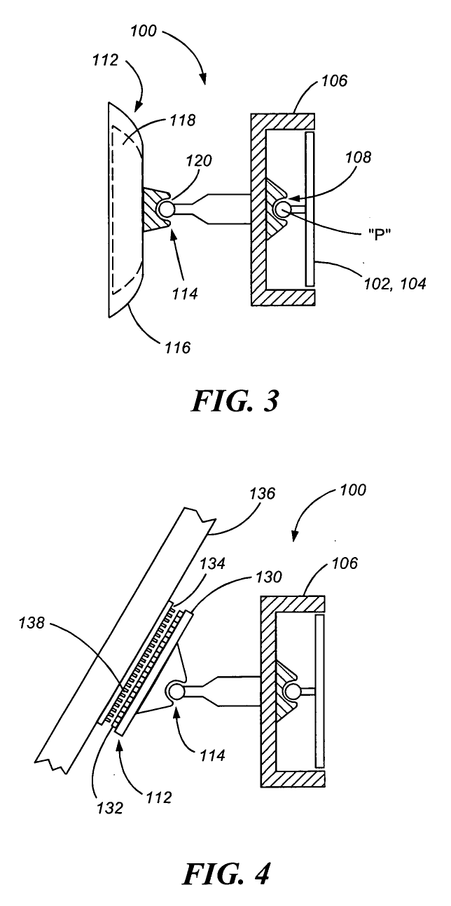

Referring to FIG. 3, the first and second mirrors 102 and 104 are coupled to the frame 106 with a mirror adjustment member 108. The mirror adjustment member 108 allows for independent adjustment and positioning of the first and second mirrors 102 and 104 with respect to the frame member 106 and each other about multiple axes. The mirror adjustment member 108 can be, for example, a ball and socket joint, allowing the first and second mirrors 102 and 104 to be pivotally adjustable about a central point “P.”

An attachment member 112 is provided for attaching the rear view safety mirror 100 to a front portion of the motor vehicle. A frame adjustment member 114 is interposed between the attachment member 112 and the frame 106, allowing adjustment of the position of the frame 106. The first and second mirrors are adjustably positionable relative to the front portion of the motor vehicle by a plurality of position adjustment points such that a person in the front portion of the motor vehicle viewing through one of the first and second mirrors has facilitated rear viewing of a rear area in the motor vehicle.

The attachment member 112 can be, for example, a suction cup 116. The suction cup 116 attaches the rear view safety mirror 100 to a relatively smooth surface, such as to a front windshield of the motor vehicle. The rear view safety mirror 100 can be centrally located in the front portion of the motor vehicle, for example, being attached to the front windshield either above or below the factory installed rear view mirror. However, it is contemplated the rear view safety mirror 100 can be attached to the front windshield, offset from the factory installed rear view mirror.

Alternatively, the attachment member 112 can comprise a double suction cup configuration 116, 118 for the attachment member 112. The double suction cup configuration 116, 118 includes a first (outer) suction cup 116 and a second (inner) suction cup 118 disposed within the first suction cup 116. This double suction cup configuration 1 16,118, for the attachment member 112 can significantly increase the holding power of the attachment member 112 for enhancing the securing power holding the rear view safety mirror 100 in a desired location. Additionally, the double suction cup configuration 116, 118 can be made of a transparent material such that light substantially passes through the double suction cup configuration 116, 118 allowing the driver unobstructed viewing of the front windshield area where the attachment member 112 holds the rear view safety mirror 100 securely to the vehicle.

Referring to FIG. 4, the exemplary attachment member 112 includes hook and loop type fasteners. The attachment member 112 includes a plate member 130 affixed to the frame adjustment member 114. The plate member 130 can be of any shape, including, but not limited to, circular, rectangular, or elliptical. A first hook and loop fastener portion 132 is attached to the plate member 130 and a second hook and loop fastener portion 134 is attached to the surface intended to support the rear view safety mirror 100, such as the front windshield 136. To secure the rear view safety mirror 100 to the windshield 136 the first and second hook and loop fastener portions 132 and 134 are pressed together in a removable engagement arrangement.

Similar to the mirror adjustment member 108 discussed above, and as shown in FIG. 3, the frame adjustment member 114 shown in FIG. 4 can comprise a ball and socket joint 120. The ball and socket joint 120 allows the frame member 106 to be adjusted about multiple axes. It is contemplated that a single centrally located attachment member 112 can be utilized to attach the rear view safety mirror 100 to a front windshield of the motor vehicle. Alternatively, multiple attachment members 112 can be utilized to attach the rear view safety mirror 100 to the surface intended to support the rear view safety mirror 100, such as the front windshield of the motor vehicle. In such multiple attachment members configuration, each of the multiple attachment members 112 is independently adjustable for enhanced adjustment flexibility for the rear view safety mirror 100.

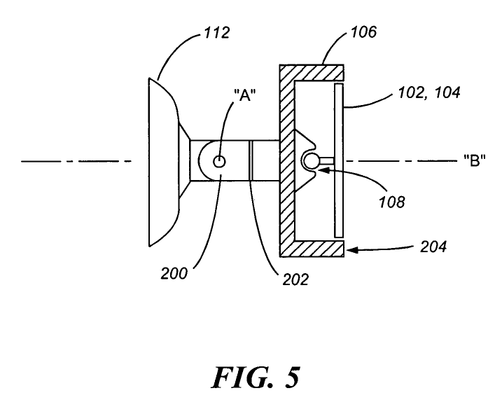

Referring to FIG. 5, the frame adjustment member 114 comprises a hinge joint 200. The hinge joint 200 allows the frame member 106 to be pivoted with respect to the frame attachment member 112, about hinge central axis “A.” The hinge joint 200 can be selectively rotationally positioned using frictional hinge engagement, such that the frame member 106 is pivoted with respect to the frame attachment member 112 from a first position to a second position, wherein the hinge joint 200 maintains the frame member 106 in the second position. Alternatively, the hinged joint 200 can be any type of hinge joint which permits the frame member 106 to be pivoted with respect to the attachment member 112 from a first position to a second position, wherein the hinge joint 200 maintains the frame member 106 in the second position, as should be obvious to those of ordinary skill in the art in view of the present discussion.

To provide further adjustability, according to the present example, the frame adjustment member 114 further includes a swivel joint 202 interposed between the hinge joint 200 and the frame member 106. The swivel joint 202 is rotatable about an axis “B” orthogonal to a front surface 204 of the frame member 106. The swivel joint 202 can be selectively rotationally positioned using frictional joint engagement, such that the frame member 106 is rotated with respect to the hinge joint 200 from a first position to a second position, wherein the swivel joint 202 maintains the frame member 106 in the second position. Alternatively, the swivel joint 202 can be interposed between the hinge joint 200 and the attachment member 112, as should be obvious to those of ordinary skill in the art in view of the present discussion. The first and second mirrors can be adjustably positionable relative to the front portion of the motor vehicle by a plurality of position adjustment points such that a person in the front portion of the motor vehicle viewing through one of the first and second mirrors has facilitated rear viewing of a rear area in the motor vehicle. Note that in this example, there are several position adjustment points including the hinge joint. 200, the swivel joint 202, and the mirror adjustment member 108 comprising a ball and socket joint. Many other combinations of position adjustment points will be obvious to those of ordinary skill in the art in view of the present discussion.

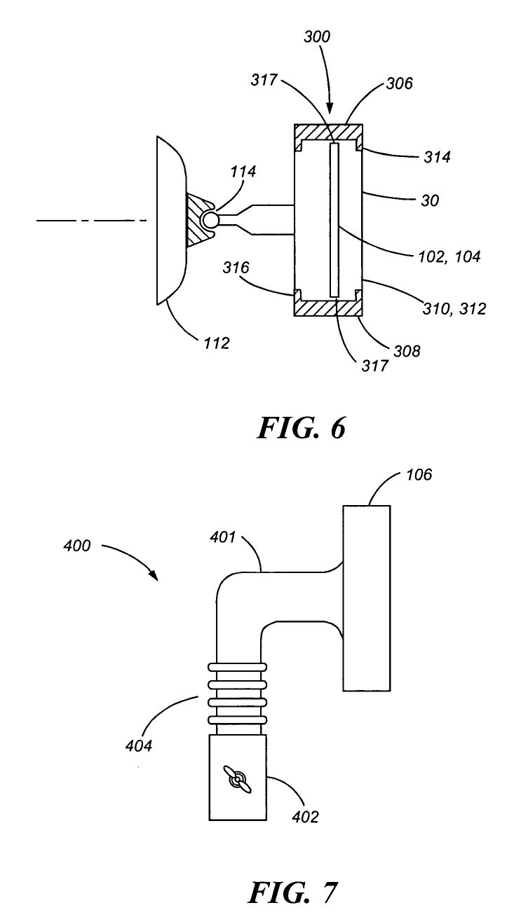

Referring to FIG.6, the frame member 106 comprises an open frame 300. The frame adjustment member 114, in this example, is shown including a ball and socket joint. However, it should be clear from the present discussion that any number of position adjustment points may be included in the frame adjustment member 114. For example, the frame adjustment member 114 could include any combination of a swivel joint 202, a hinge joint 200, and a ball and socket joint, within the scope of the present invention. The open frame 300 has first and second open frame members 302 and 304 configured for receiving the first and second mirrors 102 and 104. (See also FIG. 2). Each of the first and second open frame members 302 and 304 includes an upper, lower, first, and second side portions 306, 308, 310 and 312, each having front and rear stops 314 and 316. The mirrors 102 and 104 are positioned within the frame member 302 and 304, wherein the front and rear stops 314 and 316 maintain the mirrors 102 and 104 secured within the frame members 302 and 304. The mirrors 102 and 104 are independently adjustable, wherein a frictional connection between the edge portions 317 of the mirrors 102 and 104 and the side portions 306, 308, 310 and 312 of the frames 302 and 304 are in a slidably frictional engagement to maintain the mirrors 102 and 104 in the adjusted positions in multiple axes. It should be clear that these slidably frictional engagements of the mirrors 102 and 104, in combination with the frame adjustment member 114, can provide a plurality of position adjustment points for the mirrors 102 and 104. This new and novel arrangement provides significant flexibility in adjusting the positions of the mirrors 102 and 104, according to alternative embodiments of the present invention.

Referring to FIG. 7, an alternative embodiment of the rear safety mirror 400 is shown. The rear view safety mirror 400, according to the present example, includes first and second mirrors 102 and 104, wherein the first and second mirrors are independently positioned in frame member 106. (See also FIG. 2) The independent positioning of the first and second mirrors 102 and 104 allows the first and second mirrors 102 and 104 to be independently adjusted within the frame 106.

As shown in FIG. 3, the first and second mirrors 102 and 104 are coupled to the frame 106 with a mirror adjustment member 108. The mirror adjustment member 108 allows for independently adjustment and positioning of the first and second mirrors 102 and 104 with respect to the frame member 106 and each other about multiple axes.

Referring Again to FIG. 7, a rear support structure 401 is attached to the frame member 106 and includes an attachment member 402 for attaching the rear view safety mirror 400 to another object that is stationary in the front portion of the motor vehicle, such as for attaching to the factory installed rear view mirror on the front windshield of the motor vehicle. A frame adjustment member 404 positioned on the rear support structure 401, interposed between the attachment member 402 and the frame 106, thereby allowing adjustment of the position of the frame 106. The attachment member 402, in the present example, attaches the rear view safety mirror 400 to the factory installed rear view mirror, being positioned either above or below the factory installed rear view mirror.

The frame adjustment member 404 comprises a goose neck 404, a semi-rigid member moveable from a first position to a second position, wherein the semi-rigid member 404 is maintained in the second position. The goose neck 404 is adjustable in multiple directions, rotationally, linearly, and telescopically, allowing the frame member 106 to be selectively rotated about multiple axes and selectively positioned across multiple planes such as provided by telescopic movement. This goose neck 404 arrangement can provide a plurality of position adjustment points for the mirrors 102 and 104, allowing significant flexibility in adjusting the position of the mirrors 102 and 104.

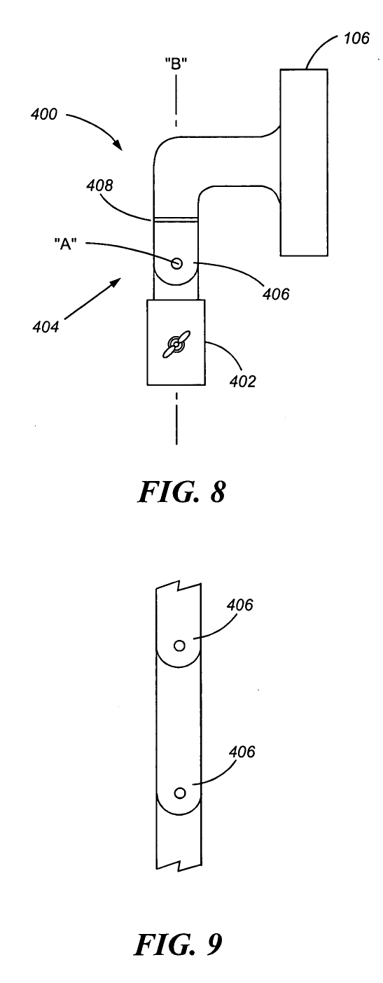

Referring to FIG. 8, the frame adjustment member 404 comprises a hinge joint 406. The hinge joint 406 allows the frame member 106 to be pivoted about a central axis “A” of the hinge joint 406. The hinge joint 406 can be in frictional hinge, such that the frame member 106 is pivoted with respect to the frame attachment 402 from a first position to a second position, wherein the hinge joint 406 maintains the frame member 106 in the second position. Alternatively, the hinged joint 408 can be any hinge joint which permits the frame member 106 to be pivoted with respect to the attachment member 402 from a first position to a second position, wherein the hinge joint 406 maintains the frame member 106.

To provide further adjustability, the frame adjustment member 404 further includes a swivel joint 408 interposed between the hinge joint 406 and the frame member 106. The swivel joint 408 is rotatable about an axis “B” orthogonal to the hinge joint central axis “A.” The swivel joint 408 can be in frictional joint engagement such that the frame member 106 is rotated with respect to the hinge joint 406 from a first position to a second position, wherein the swivel joint 408 maintains the frame member 106 in the second position. Alternatively, the swivel joint 408 can be interposed between the hinge joint 406 and the attachment member 402. Referring to FIG. 9, the frame adjustment member 404 can include multiple hinge joints 406.

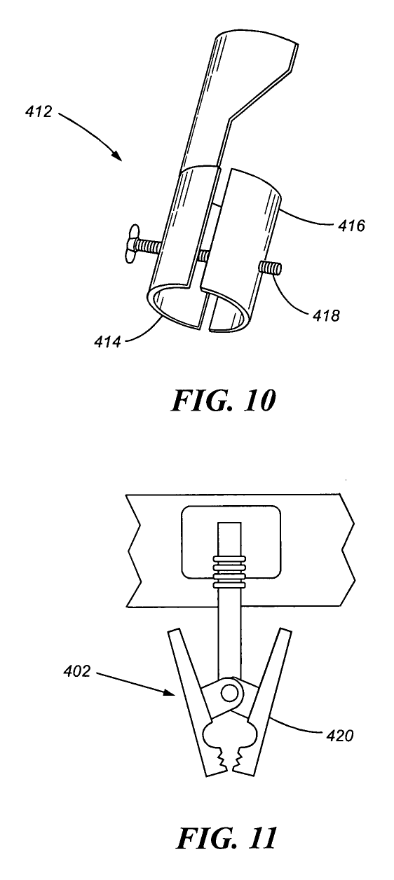

Referring to FIG. 10, the attachment member 402 comprises a clamp 412. The clamp 412 includes a first portion 414 and a second portion 416. A threaded member 418 connects the first and second portions 414 and 416, such that a rotation of the threaded member 418, such as a thumb screw, a threadable fastener, or the like, moves the first portion 414 with respect to the second portion 416. A rotation of the threaded member 418 in a first direction moves the first portion 414 towards the second portion 416, closing the clamp 412, and securing the rear view safety mirror 400 to, for example, the factory installed rear view mirror. A rotation of the threaded member 418 in a second direction moves the first portion 414 away from the second portion 416, opening the clamp 412, allowing for removal of the rear view safety mirror 400 from the factory installed rear view mirror, in this example.

Referring to FIG. 11, the attachment member 402 comprises a spring-loaded clip 420. The spring loaded clip 420 removably attaches the rear view safety mirror 400 to another object, such as the factory installed rear view mirror. The rear view safety mirror 400, in this example, can be positioned either above or below the factory installed rear view mirror.

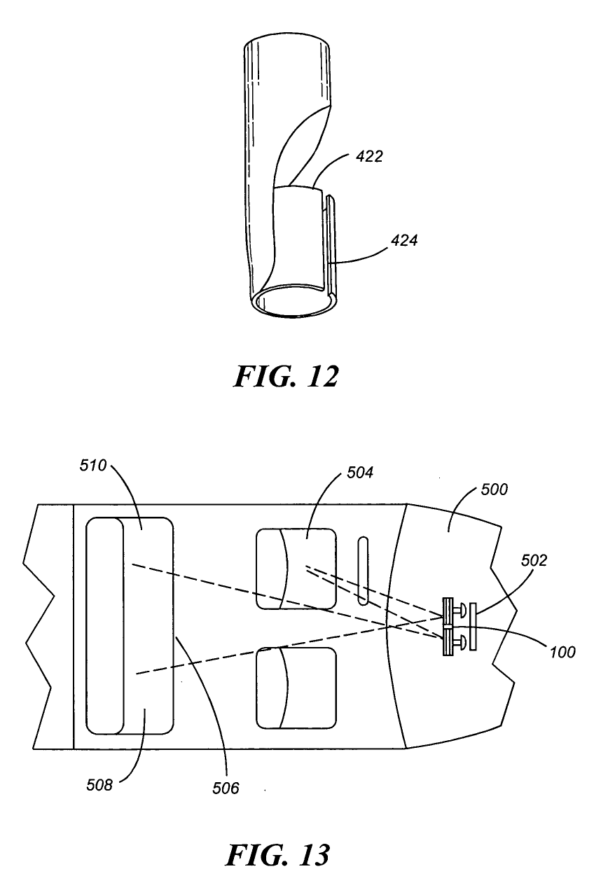

Referring to FIG. 12, the attachment member 402 comprises a resilient clip 422. The resilient clip 422 comprises a slotted sleeve 424, being formed of an elastically resilient material. The resilient clip 422 removably attaches the rear view safety mirror 400 to an object such as the factory installed rear view mirror or such as to a sun visor of a vehicle. In this example, the rear view safety mirror 400 can be positioned proximal to the factory installed rear view mirror, such as above, below, to the left of, and/or to the right of, the factory installed rear view mirror.

Referring to FIG. 13, in exemplary use the rear view safety mirror 100 is attached proximal to the front windshield 500, either above or below the factory installed rear view mirror 502. The first and second mirrors 102 and 104 are independently adjusted, such that a driver 504 can view substantially all of the rear seating area 506. (See also FIG. 2). For example, the first mirror 102 is adjusted such that the driver 504 can view a first portion 508 of the rear seating area 506 and the second mirror 104 is adjusted such that the driver can view a second portion 510 of the rear seating area 506. The first portion 508, in this example, comprises a portion of the rear seating area 506 substantially behind the front passenger seat, while the second portion 510 comprises a portion of the rear seating area 506 substantially behind the driver's seat. A child seated in either the first portion 508 or the second portion 510 will be visible to the driver of the motor vehicle.

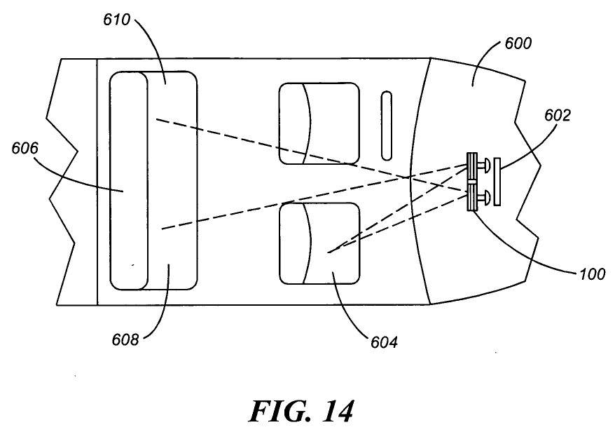

Referring to FIG. 14, in further exemplary use the rear view safety mirror 100 is attached proximal to the front windshield 600, either above or below the factory installed rear view mirror 602. The first and second mirrors 102 and 104 are independently adjusted, such that a passenger in the front passenger seat 604 can view substantially all of the rear seating area 606. (See also FIG. 2). For example, the first mirror 102 is adjusted such that the passenger 604 can view a first portion 608 of the rear seating area 606 and the second mirror 104 is adjusted such that the passenger 604 can view a second portion 610 of the rear seating area 606. The first portion 608, in this example, comprises a portion of the rear seating area 606 substantially behind the front passenger seat, while the second portion 610 comprises a portion of the rear seating area 606 substantially behind the driver's seat. A child seated in either the first portion 608 or the second portion 610 will be visible to the driver of the motor vehicle.

While in the above example, the rear view safety mirror 100 has been described as allowing viewing of the rear seating area by only the driver or the passenger, it is contemplated that the rear view safety mirror 100 can be positioned and the first and second mirrors 102 and 104 can be adjusted to provide contemporaneous viewing of any portion of an area in a vehicle, such as the entire rear seating area or a cargo area, by both the driver and a passenger in the front passenger seat.

The rear view safety mirror of the present invention can be used in any motor vehicle which transports persons or any objects needing monitoring and that are located in the rear portion of the motor vehicle such as in the rear seating area, or in a cargo area. For example, in family cars the driver and/or front passenger may view children, or anyone or anything, located in the rear seating area. Similarly, the rear view safety mirror can be used in commercial or law enforcement vehicles, such as taxi cabs or police cars, where for security and safety reasons it is desirable to view persons and/or objects located in the rear seating area of the vehicles.

It is also contemplated that the rear view safety mirror can be used in material transport vehicle, such as delivery trucks or hazardous waste vehicles. The rear view safety mirror provides a full field view of the rear portion of the vehicle, such that a driver or passenger can continually monitor the placement, securement, and integrity of the materials being transported. It should be obvious to those having ordinary skill in the art in view of the present discussion that many types of vehicles could use an embodiment of the present invention to allow the front seated persons, whether the driver or a passenger in the front seat, to view portions, or to view an entire full view, of the rear area of the inside of a vehicle. Additionally, alternative embodiments of the rear view safety mirror 100 allow users significant flexibility in positioning, and rotating in multiple axes, the rear view safety mirror device 100, and further allow the users to additionally adjust the mirror in the device 100 in multiple axes. This provides maximum flexibility for a user to orient one or more mirrors in a rear view safety mirror device 100 to cover many different types of environments and custom applications. As an alternative example, a rear view safety mirror device 100 may include at least one frame member that supports at least one mirror. The at least one supporting frame member in this alternative example comprises at least one adhering surface that secures to a back surface of the at least one mirror. The at least one supporting frame member then is mechanically coupled to an adjustment member, such as adjustment member 108 shown in FIG. 3, to allow for independent adjustment and positioning of the at least one mirror secured to the at least one supporting frame member. Note that, however, in this example there is no surrounding frame member 106 such as shown in FIG. 3. The at least one adjustment member 108 is mechanically coupled to the at least one supporting frame member that secures to the back side of the at least one mirror. An adjustment member can comprise, for example, a ball and socket joint. This allows the mirror to be pivotally adjustable about a central point in the adjustment member. The adjustment member, in this example, could then also be mechanically secured to a second adjustment member 120 (see for example as shown FIG. 3) and to a securing member 112 (such as shown in FIG. 3) for attaching the rear view safety mirror 100 to a front portion of the motor vehicle. The at least one mirror can be adjustably positionable relative to the front portion of the motor vehicle by a plurality of position adjustment points such that a person in the front portion of the motor vehicle viewing through the at least one mirror has facilitated rear viewing of a rear area in the motor vehicle.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A rear view safety mirror for a motor vehicle, comprising:
a frame that is attachable to a front portion of a motor vehicle, the frame being locatable in the front portion of the motor vehicle independent of a separate rear view mirror of the motor vehicle used for viewing outside of the motor vehicle; and
consisting of a first and second mirror that are located within the frame and independently adjustably attached to the frame, the first mirror being adjustably positionable within and relative to the frame such that a person in the front portion of the motor vehicle viewing through the first mirror has facilitated rear viewing of a rear area inside and behind the front portion of the motor vehicle and the second mirror being adjustable positionable within and relative to the frame such that a person in the front portion of the motor vehicle viewing through the second mirror has facilitated rear viewing of a rear area inside and behind the front portion of the motor vehicle.

2. The rear view safety mirror of claim 1, wherein the frame including at least a first frame section and a second frame section within the frame, and
the first mirror is adjustably positionable in the first frame section relative to the frame; and
the second mirror is adjustably positionable in the second frame section relative to the frame and further comprising:
a support structure, mechanically coupled with the frame, and including:
an adjustment member for adjusting a position of the frame; and
an attachment member for attaching the frame to the motor vehicle.

3. The rear view safety mirror of claim 2, wherein the adjustment member comprises a multiple axis adjustment member.

4. The rear view safety mirror of claim 2, wherein the adjustment member comprises a ball joint.

5. The rear view safety mirror of claim 2, wherein the adjustment member comprises a hinge joint.

6. The rear view safety mirror of claim 2, wherein the adjustment member comprises a goose neck.

7. The rear view safety mirror of claim 2, wherein the attachment member is attached to a front window of the motor vehicle.

8. The rear view safety mirror of claim 7, wherein the attachment member comprises at least one suction cup.

9. The rear view safety mirror of claim 2, wherein the attachment member is directly attachable to a rear view mirror of a vehicle.

10. The rear view safety mirror of claim 9, wherein the attachment member comprises a clamp.

11. The rear view safety mirror of claim 9, wherein the attachment member comprises a clip.

12. (canceled)

13. The rear view safety mirror of claim 2, wherein the first and second mirrors are independently adjustable such that a person, other than the driver of the motor vehicle, in the front portion of the motor vehicle and viewing through at least one of the first and second mirrors has facilitated rear viewing of a rear area inside and behind the front portion of the motor vehicle.

14. A rear view safety mirror for a motor vehicle, comprising:
a frame that is attachable to a front portion of a motor vehicle, the frame further being locatable in the front portion of the motor vehicle independent of a separate rear view mirror of the motor vehicle used for viewing outside of the motor vehicle, the frame including a first side and at least a second side, the first side providing a first frame section and a second frame section within the frame; and
first and second support structures, mechanically coupled to the frame and affixed to the at least a second side of the frame, each of the first and second support structures including an attachment member for attaching to the motor vehicle: and further consisting of:
a first mirror adjustably positionable in the first frame section relative to the frame; and
a second mirror adjustably positionable in the second frame section relative to the frame such that a person, other than the driver, in the front portion of the motor vehicle and viewing through at least one of the first and second mirrors has facilitated rear viewing of a rear area inside and behind the front portion of the motor vehicle.

15. The rear view safety mirror of claim 14, wherein the first and second mirrors are independently adjustable about multiple axes.

16. (canceled)

17. The rear view mirror of claim 14, wherein the first and second support structure attachment members comprise suction cups.

18. A method of viewing a rear area inside and behind a front portion of a motor vehicle, comprising:
attaching to a front portion of a motor vehicle a rear view safety mirror consisting of first and second independently adjustable mirrors located Within a frame of the rear view safety mirror, wherein the rear view safety mirror is independent of a separate rear view mirror of the motor vehicle used for viewing outside of the motor vehicle; and
adjusting the first independently adjustable mirror to a first position within and relative to the frame such that a person in the front portion of the motor vehicle and viewing through the first independently adjustable mirror has facilitated rear viewing of a first rear area inside and behind the front portion of the motor vehicle.

19. The method of claim 18, further comprising:
adjusting the second independently adjustable mirror to a second position within and relative to the frame such that a person, other than the driver of the motor vehicle, in the front portion of the motor vehicle and viewing through the second independently adjustable mirror has facilitated rear viewing of a second rear area inside and behind the front portion of the motor vehicle, and wherein the first rear area and the second rear area are different from each other.

20. The method of claim 19, wherein the first position and the second position are selected by the adjusting of the first and second independently adjustable mirrors such that the first rear area and the second rear area are viewable through the first and second independently adjustable mirrors, respectively, by a person, other than the driver, and located at a front passenger seat in the front portion of the motor vehicle.

21. The method of claim 19, wherein the first position and the second position are selected by the adjusting of the first and second independently adjustable mirrors such that the first rear area and the second rear area are contemporaneously viewable through the first and second independently adjustable mirrors, respectively, by both the driver of the motor vehicle and a person, other than the driver, and located at a front passenger seat in the front portion of the motor vehicle.

22. The rear view safety mirror of claim 1, further comprising:
a support structure, mechanically coupled with the frame, and including an attachment member comprising at least one hook and loop type fasteners for attaching the frame to the motor vehicle.
